(19) United States
(12) Patent Application Publication
(10) Pub. No.: US 2016/0208205 A1
(43) Pub. Date: Jul. 21, 2016

(54) METHOD FOR PRODUCTION OF BEER

(71) Applicant: Gilbert MOSER, Mooskirchen (AT)

(72) Inventor: Gilbert Moser, Mooskirchen (AT)

(21) Appl. No.: 15/023,158

(22) PCT Filed: Oct. 2, 2014
(86) PCT No.: PCT/EP2014/071199

§ 371 Date: Apr. 4, 2016

(30) Foreign Application Priority Data
Oct. 4, 2013 (AT) A 50642/2013

(51) Int. Cl. C12C 7/06; C12C 13/10; C12C 7/165

(52) U.S. Cl. CPC C12C 7/06; C12C 7/165; C12C 13/10

(57) ABSTRACT

The invention relates to a method for production of beer, in which the mashing is conducted in a first vessel (1) with supply of heat and while stirring, and the mash thus produced is then lautered in the same vessel (1), and then the wort boiling, the cooling of the wort, the hot and cold trub separation and finally the fermentation is conducted. A simplification of the method can be achieved through lautering by drawing the wort through a filter plate (3) in the first vessel (1).

The invention relates to a method for the production of beer, in which the mashing is conducted in a first vessel with supply of heat and under stirring, and the mash thus produced is then lautered in the same vessel, and the wort boiling, the cooling of the wort, the hot and cold trub separation and finally the fermentation are conducted thereafter.

The production of beer in small and very small breweries is increasingly gaining in importance, since it is possible in this manner to take the aspects of craftsmanship in the production especially into account. In order to limit the costs in production, the complexity of the equipment must be kept as low as possible, whereas efficiency within the terms of high throughput has a slightly lower relevance.

A minimisation in the required repair is achieved in a solution as proposed in DE 10 2005 012 076 A. The mashing is carried out in this case in a screen which is inserted into a vessel. The lautering is carried out in that the screen is pulled out of the vessel, It is obvious that the method and apparatus are very simple, but they are also not capable of performing an even only averagely sophisticated brewing method, since sparging is not provided at all for example.

DE 10 2005 002 741 A discloses a small-size brewing plant with vessels which are arranged on top of each other in the manner of a tower and which are installed in a single enclosure. This allows a certain constructional simplification, but the individual method steps are carried out in a conventional manner in different vessels.

A cylindro-conical vessel is known from WO 2009/017428 A, which is provided for the fermentation process however. The process of mashing and lautering is not mentioned explicitly.

U.S. Pat. No. 755,144 A relates to a method and vessel for steeping grain. DE 2 329 360 B discloses a method and a vessel for separating mash and grape marc. It is not possible to use these vessels for the production of beer in such a way that a minimum additional need for equipment is necessary.

A cylindro-conical vessel is known from DE 1 964 416 A, which is provided as a lauter tub. A propeller arranged directly on the base is used for circulation. It does not allow the use of the grape marc as an auxiliary filter agent, so that only a low level of brightness is achieved.

It is the object of the present invention to provide a method for the production of beer, which on the one hand places the lowest possible demands on the required equipment, but which on the other hand offers the possibility to carry out all method steps which are required or indicated for the production of beer of the highest quality.

This object is achieved in accordance with the invention in such a way that lautering is performed in that the wort is drawn through a filter base of the first vessel. In the method in accordance with the invention, the vessel in which the mashing is performed can also be used for the process of lautering.

It is always necessary for the process of mashing to mix the vessel content by stirring, According to a special embodiment of the method in accordance with the invention, mixing occurs in such a way that an agitator is moved in the mash, wherein a supernatant liquid above the agitator is nearly free from stirring movement. This ensures in particular that during the mashing liquid from the supernatant liquid is guided from below back into the vessel in which the thick mash is present. In addition to an improved circulation of the vessel content, this also allows a more precise setting of the temperature of the wort, since the extracted liquid can accordingly be tempered in heat exchangers during the mashing. The principal setting of the temperature of the mash occurs above a heating zone which is provided in the cylindrical portion of the vessel wall. It is an additional advantage of this type of backflushing that the bottom portion of the vessel, which is not included in the actual movement of the agitator, is circulated accordingly.

Lautering occurs in that the wort is drawn off downwardly through the filter base and is stored in an intermediate vessel. As in conventional methods, the grape marc cake deposited on the screen of the filter base acts as the actual filter which retains the suspended matter from the wort. Sparging occurs after the lautering in typical methods, wherein further leaching of the grape marc occurs by scavenging with hot water. According to a preferred Variant of the method in accordance with the invention, this is carried out in such a way that the water is pumped in at least partly from below through the filter cake, Loosening of the grape marc cake occurs in this manner, which ensures that the ingredients can be leached with a lower water quantity. It is especially advantageous that the removal of the grape marc can occur without any mechanical aid through a raking machine.

The aforementioned effects can especially be increased in such a way that inert gas is introduced together with the water, Additional loosening of the grape marc cake can thus be achieved.

A further simplification of the equipment can be achieved in such a way that the wort, after the lautering, is returned back to the first vessel and is boiled there by adding hops. The first vessel assumes the function of the liquid pan. The boiling not only promotes the evaporation of water, but valuable constituents of the hops are isomerized and released. This is important for the colour development and formation of flavour, the evaporation of undesirable flavouring agents, the removal of protein, the sterilisation of the wort and the destruction of the enzymes.

It is especially advantageous if after the boiling the hot trub separation and the cold trub separation is carried out in a combined manner in the first vessel. It is carried out in the manner that cooling is commenced immediately after boiling. In this process, the hot wort is extracted by suction slightly beneath the level of the wort and cooled in an external cooler and returned to the vessel from below. After the cooling of the wort, the transfer to the fermenting vat can occur, wherein hot trub and cold trub are held back in the filter base.

It is alternatively also possible that the fermentation is carried out in the first vessel. In this case, hot trub and cold trub are desludged and yeast is then added to the wort.

In any case, the application of the method in accordance with the invention allows making do without the whirlpool that is necessary otherwise, in which hot trub separation occurs typically.

The present invention also relates to an apparatus for producing beer, comprising a first vessel in which the mashing and the lautering are carried out.

In accordance with the invention, this apparatus is characterized in that the vessel comprises an upper cylindrical section and a bottom cylindrical section which is formed in the manner of a truncated cone and is formed as a filter base. The relevant aspect in the present invention is the fact that as a result of the base part formed in the manner of a truncated cone a greater filter surface is available than in the case of a flat bottom. Furthermore, the grape marc removal can occur through an opening at the tip of the truncated cone in an especially advantageous manner.

The apparatus in accordance with the invention is formed in an especially efficient way if the filter base substantially forms the entire section formed in the manner of a truncated cone.

A closable opening for grape marc removal is preferably provided at the lowest point of the truncated-cone-shaped section.

The present invention will be explained below in closer detail by reference to embodiments shown in the drawings, wherein:

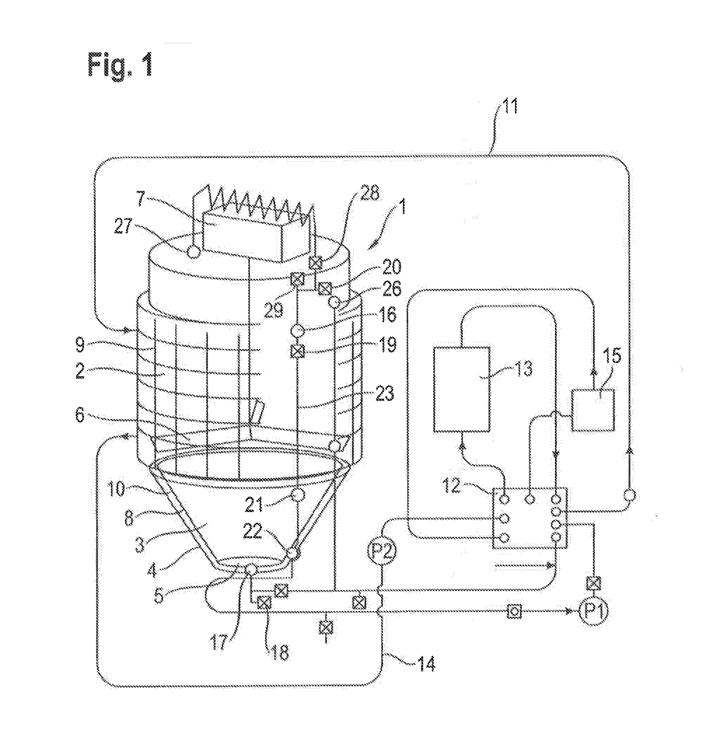

FIG. 1 shows a diagram of an installation in accordance with the invention;

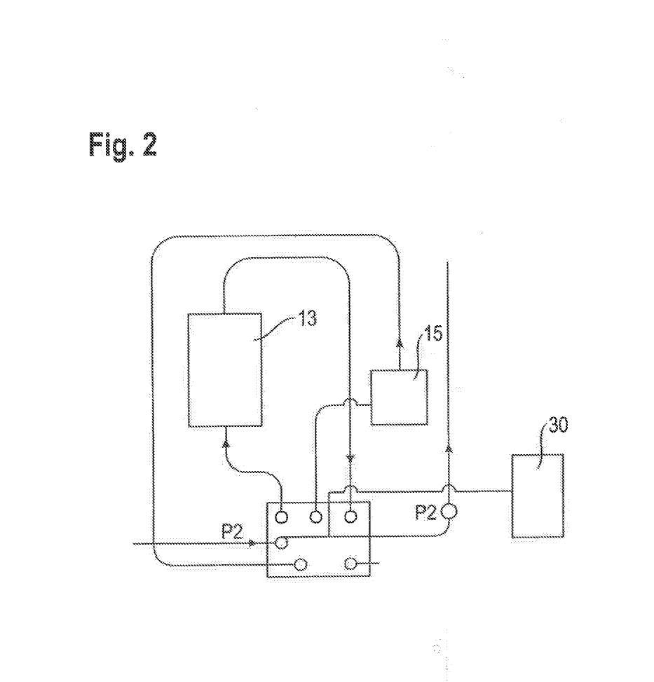

FIG. 2 shows a detail of FIG. 1;

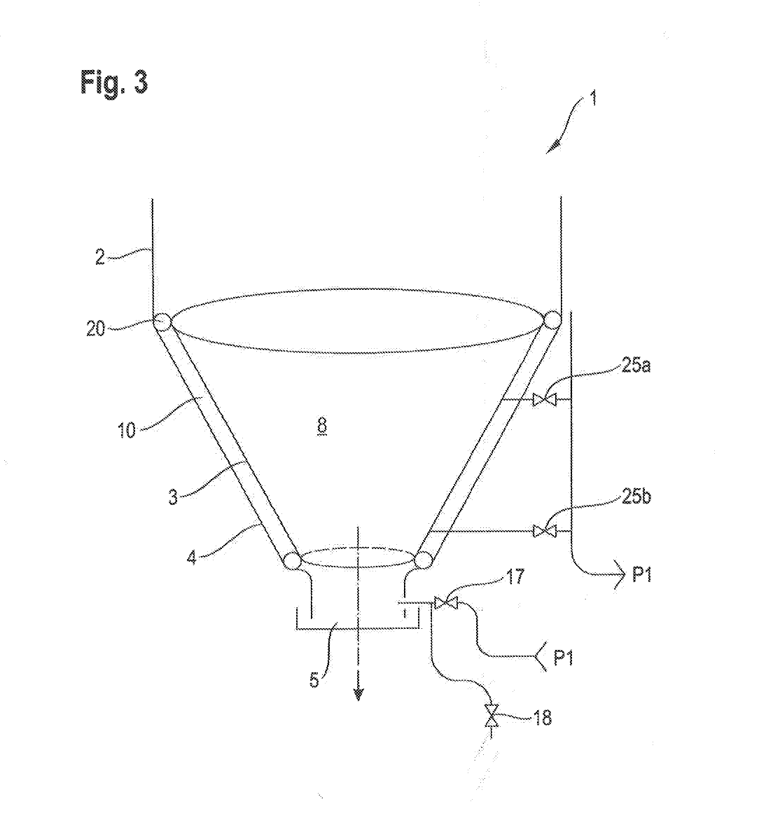

FIG. 3 shows a further detail of FIG. 1;

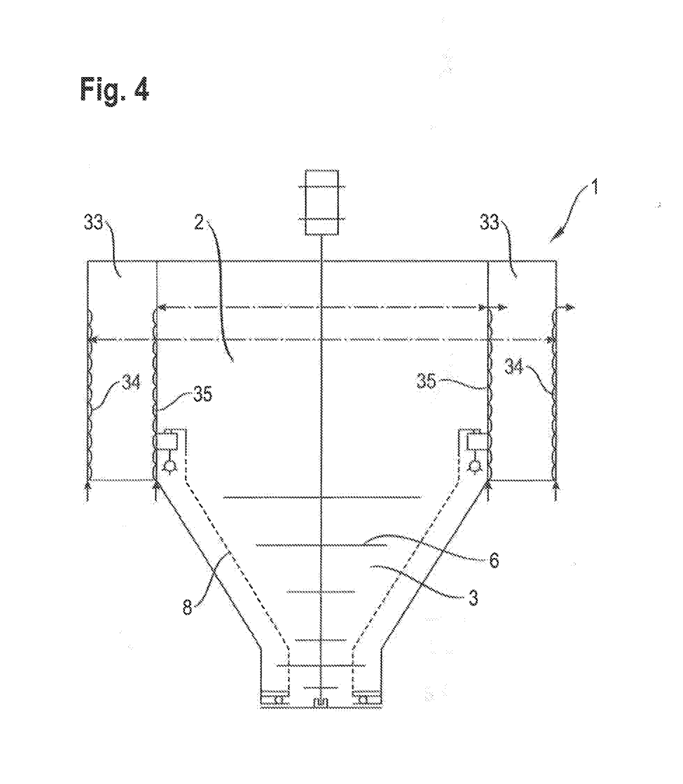

FIG. 4 shows an alternative embodiment, and

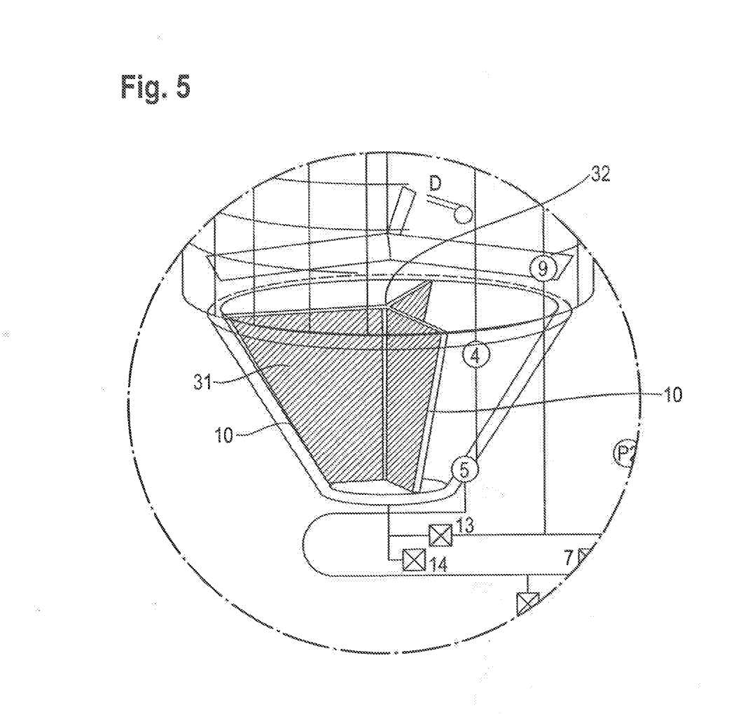

FIG. 5 shows a further alternative embodiment of the invention in detail.

The apparatus of FIG. 1 in accordance with the invention substantially consists of a cylindro-conical vessel 1 with an upper cylindrical section 2 and a bottom truncated-cone-shaped section 3, which forms the filter base and is composed of a jacket 4 and a discharge opening 5 forming the bottom termination of the vessel 1. The cylindrical section 2 is surrounded over its circumference with a heating jacket 9, which is provided for heating and also for cooling the content of the vessel 1. A rotor 6 is rotatabiy arranged within the cylindrical section 2, which rotor is used for circulating the vessel content. Said rotor 6 is driven by a gear motor 7 on the upper side of the vessel 1.

A screen 8, which is also formed in the manner of a truncated cone, is provided in the truncated-cone-shaped section 3, beneath which a screen chamber 10 is formed.

The functionality of the apparatus in accordance with the invention will be explained below in closer detail.

The grist that is ground in a special mill is mixed with water at a ratio of 1:2.5 to 1:4 for mashing and is introduced into the vessel 1. As a result, the soluble and the major part of the insoluble ingredients of the grist are enzymatically degraded and dissolved. These degradation processes are controlled by the selection of temperature and reaction time.

The required heat is mainly supplied via the heating jacket 9, which is supplied via a supply line 11 with a heating medium such as hot water. The supply line 11 is connected to a panel 12, with which the different operating states can be triggered as required. The supply of heat to the heating jacket 9 occurs in the manner that the supply line 11 is interconnected with a heat exchanger 13, which is also known as a boiler and which is supplied via a return line 14 with cooled heating medium, thus closing the heating circuit. The circulation is driven via a speed-controlled pump P2.

If the content of the vessel needs to be cooled, the circuit is guided via a further heat exchanger 15 which is formed as a cooler.

During the mashing process, the content of the vessel 1 is carefully circulated by the rotor 6, wherein the major part of said circulation is only limited to the middle height section of the content. A portion of the vessel content is extracted simultaneously or in an alternating manner with the stirring movement through an upper opening 16 and conveyed via a pump P1 to a valve 17 in the region of the discharge opening 5 and returned to the vessel 1.

At the same time, inert gas, preferably carbon dioxide, is injected in an especially preferred manner via a valve 18 into the vessel 1, thus, additionally amplifying the thorough mixing. It is a further effect of the use of an inert gas that the fine mash components are driven upwardly in the manner of flotation and thus do not block the grape marc cake.

Lautering occurs after mashing, in which the ingredients (wort) released during mashing from the malt are separated from the insoluble ingredients (grape marc), and the filter cake is leached. This process is typically subdivided into two phases: the clarification of the first wort, in which the concentrated wort is clarified, and the sparging in which the leaching of the grape marc cake is carried out by the supply of water.

It is a special aspect of the present invention that lautering is carried out in the same vessel as the mashing. The clarification of the first wort or advancement is carried out in that the valves 19, 28 are opened in the discharge line 23, so that liquid can flow out of the openings 21, 22 from the screen chamber 10. It is important that the outflow of the liquid from the vessel 1 occurs by gravity and not by the suction effect of a pump. The open valves 19, 28 allow the formation of a free liquid level, so that air can flow from above. At the start of lautering, the turbid liquid is pumped back to the vessel 1 via the valve 26. Only when the liquid is clear will it be transferred from the vessel 1 to a buffer tank 30, which is shown in FIG. 2. A water valve 29 allows the selective addition of water, and the valve 28 is used for venting and for carrying out CIP cleaning via a spray head 27.

Sparging is carried out in that water is added, which is then also guided downwardly through the filter cake and is withdrawn. Hot water is added from above in conventional brewing methods. It is preferable in connection with the present invention however that the water is pressed entirely or at least partly from below through the grape marc cake. Especially good leaching can be achieved in this way.

The further conventional method steps in the production of beer, i.e. the boiling of wort, the cooling of wort, hot and cold trub separation can be carried out in the vessel 1, in that the wort is guided back to the vessel 1 after the removal of the grape marc, or in a special fermentation vat (not shown in closer detail).

FIG. 3 shows the truncated-cone-shaped section in detail. The screen chamber 10 is sealed at the top with a seal 20 at the transition point to the cylindrical section 2. The valves 25a, 25b are used to discharge the content of the screen chamber 10.

The embodiment of FIG. 4 differs from the embodiments described above in such a way that an annular space 33 is arranged around the cylindrical section 2 of the vessel 1, which is used to briefly relocate the lautering wort after lautering in order to clean the vessel. The buffer tank 30 can thus be avoided. The apparatus is thus compact and thermally optimised.

The heat exchanger surfaces 34 and 35 are used to enable the selective heating or cooling of the content of vessel 1 and the annular space 33 in order to optimise the method.

FIG. 5 shows an alternative embodiment of the invention, in which perpendicular filter elements are provided in form of three radial double plates 31, which originate from a common axial section 32. The screen chamber 10 is formed in the interior of the double plates 31. This allows further enlarging the filter surface.

1-16. (canceled)

17. A method for the production of beer, comprising the following steps:
introducing grist mixed with water into a first vessel;
mashing the content of the first vessel with supply of heat and under stirring;
lautering the mash in the same first vessel by drawing it off downwardly through a filter base of the first vessel and storing it in an intermediate vessel;
thus produced in the same vessel, and the wort boiling, the cooling of the wort, the hot and cold trub separation and finally the fermentation are conducted thereafter.

18. The method according to claim 17, wherein stirring occurs in that an agitator is moved in the mash beneath a supernatant liquid, as a result of which a supernatant liquid above the agitator is substantially free from stirring movement.

19. The method according to claim 18, wherein liquid from the supernatant liquid is returned through the filter base to the first vessel during mashing.

20. The method according to claim 17, wherein sparging occurs after lautering, in that water is pumped from below through the filter base into the first vessel.

21. The method according to claim 20 wherein inert gas is introduced through the filter base together with the water.

22. The method according to claim 17, wherein the wort is returned to the first vessel again after lautering and is boiled there.

23. The method according to claim 22, wherein hot trub separation and cold trub separation are carried out after boiling in a combined manner in the first vessel.

24. The method according to claim 23, wherein hot wort is extracted by suction directly beneath the wort level after boiling and is cooled in an external cooler.

25. The method according to claim 17, wherein fermentation is carried out in the first vessel.

26. An apparatus for the production of beer, comprising a first vessel in which the mashing and the lautering are carried out, wherein the first vessel comprises an upper cylindrical section and a bottom cylindrical section which is formed in the manner of a truncated cone and is formed as a filter base, and a closable opening for grape marc removal is provided at the lowermost point of the truncated-cone-shaped section.

27. The apparatus according to claim 26, wherein the screen substantially covers the entire jacket of the truncated-cone-shaped section.

28. The apparatus according to claim 26, wherein the screen consists of substantially perpendicularly arranged double plates.

29. The apparatus according to claim 26, wherein a heating zone is provided on the wall of the cylindrical section.

30. The apparatus according to claim 26, wherein an external cooler is provided.

31. The apparatus according to claim 26, wherein an external boiler is provided.

32. The apparatus according to claim 26, wherein an annular space is arranged around the vessel.
